(19) United States
(12) Patent Application Publication
(10) Pub. No.: US 2020/0098009 A1
(43) Pub. Date: Mar. 26, 2020

(54) INFORMATION PROCESSING APPARATUS AND INFORMATION PROCESSING METHOD

(71) Applicant: TOYOTA JIDOSHA KABUSHIKI KAISHA, Toyota-shi (JP)

(72) Inventors: Kazuaki TAKEMURA, Nagoya-shi (JP); Yuko MIZUNO, Nagoya-shi (JP); Kohei MUTO, Toyota-shi (JP); Keiko NAGATOMI, Toyota-shi (JP); Masatoshi KOMIYAMA, Handa-shi (JP); Kuniaki JINNAI, Nagoya-shi (JP)

(73) Assignee: TOYOTA JIDOSHA KABUSHIKI KAISHA, Toyota-shi (JP)

(21) Appl. No.: 16/577,261

(22) Filed: Sep. 20, 2019

(30) Foreign Application Priority Data
Sep. 25, 2018 (JP) 2018-179008

(51) Int. Cl. G06Q 30/02; G09F 21/04

(52) U.S. Cl. CPC G06Q 30/0266; G06Q 50/01; G09F 21/04; G06Q 30/0261

(57) ABSTRACT

An information processing apparatus for displaying an advertisement using one or more vehicles having a display apparatus provided on the outside, including a control unit configured to execute processing comprising the step of obtaining location information of a first user who sees the advertisement, the first finding step of finding a first advertisement-displaying vehicle located in the vicinity of the first user, the second finding step of finding a second advertisement-displaying vehicle on the basis of a designation by the first user, and the display step of sending the advertisement displayed by the first advertisement-displaying vehicle to the second advertisement-displaying vehicle to display the advertisement by the second advertisement-displaying vehicle.

### CROSS REFERENCE TO THE RELATED APPLICATION

This application claims the benefit of Japanese Patent Application No. 2018-179008, filed on Sep. 25, 2018, which is hereby incorporated by reference herein in its entirety.

### BACKGROUND

### Technical Field

The present disclosure relates to technologies of providing advertisements using vehicles as media.

### Description of the Related Art

Advertising using vehicles as media has been developed in recent years. For example, an outside display apparatus is provided on a vehicle to display advertisements. The advertisement to be displayed is dynamically selected appropriately according to circumstances to optimize the effectiveness of advertising.

### CITATION LIST

### Patent Literature

Patent Literature 1: Japanese Patent Application Laid-Open No. 2004-361661
Patent Literature 2: Japanese Patent Application Laid-Open No. 2005-010839

### SUMMARY

One method of enhancing the effectiveness of advertisements is to allow users to share information. For example, advertising using electronic media such as social networking services (SNS) use systems that allow registered users to share information with others. However, advertising that uses vehicles as media cannot utilize such systems.

The present disclosure has been made in the above circumstances, and an object of the present disclosure is to allow users to share advertising contents that are provided using vehicles as media.

According to the first aspect of the present disclosure, there is provided an information processing apparatus for displaying an advertisement using one or more vehicles having a display apparatus provided on the outside, including a control unit configured to execute processing comprising, the step of obtaining location information of a first user who sees the advertisement, the first finding step of finding a first advertisement-displaying vehicle located in the vicinity of the first user, the second finding step of finding a second advertisement-displaying vehicle on the basis of a designation by the first user, and the display step of sending the advertisement displayed by the first advertisement-displaying vehicle to the second advertisement-displaying vehicle to display the advertisement by the second advertisement-displaying vehicle.

According to a second aspect of the present disclosure, there is provided an information processing method for displaying an advertisement using one or more vehicles having a display apparatus provided on the outside, comprising the step of obtaining location information of a first user who sees the advertisement, the first finding step of finding a first advertisement-displaying vehicle located in the vicinity of the first user, the second finding step of finding a second advertisement-displaying vehicle on the basis of a designation by the first user, and the display step of sending the advertisement displayed by the first advertisement-displaying vehicle to the second advertisement-displaying vehicle to display the advertisement by the second advertisement-displaying vehicle.

According to a third aspect of the present disclosure, there is provided a program that causes a computer to implement the above-described information processing method or a computer-readable recording medium in which the program is stored in a non-transitory manner.

The present disclosure allows users to share advertising contents that are provided using vehicles as media.

### BRIEF DESCRIPTION OF THE DRAWINGS

FIG. 1 is a diagram illustrating the general configuration of an advertisement distribution system according to an embodiment.

FIG. 2. is a diagram illustrating the configuration of the advertisement distribution system according to a first embodiment.

FIG. 3 is a diagram illustrating the system configuration of a vehicle 10 according to the first embodiment.

FIG. 4 illustrates the positions of display apparatuses provided on vehicles 10.

FIG. 5 is a diagram illustrating the system configuration of a server apparatus 20 according to the first embodiment.

FIG. 6 shows an example of an advertisement information table stored in a database.

FIG. 7 shows an example of a vehicle information table stored in a database.

FIG. 8 shows an example of a travel record table stored in a database.

FIG. 9 is a diagram illustrating the system configuration of a user terminal 30 according to the first embodiment.

FIG. 10 is a flow chart of a process executed by the server apparatus 20.

FIG. 11 is a flow chart of a process executed by the vehicle 10.

FIG. 12 is a flow chart of a process of sharing an advertisement.

FIG. 13 a diagram illustrating the configuration of the advertisement distribution system according to a second embodiment.

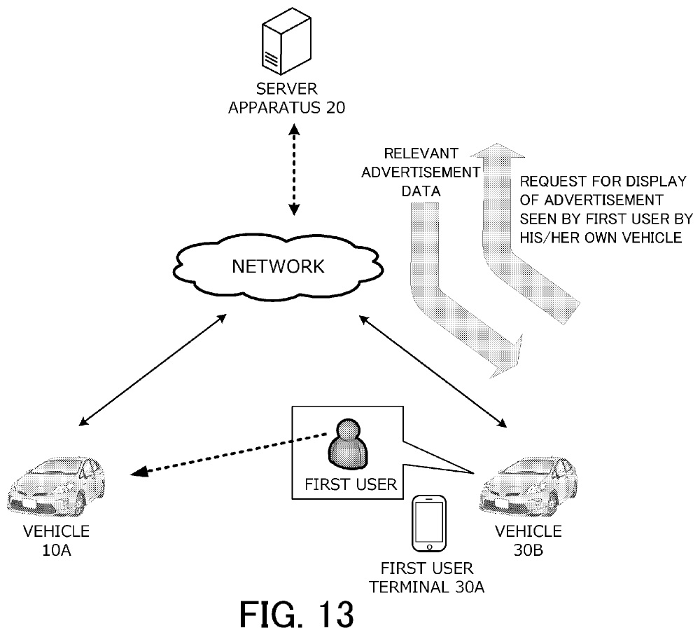

FIG. 14 shows an example of an advertisement information table according to a third embodiment.

### DESCRIPTION OF THE EMBODIMENTS

An advertisement distribution system according to the present disclosure includes a server apparatus and a plurality of vehicles. The server apparatus distributes advertisements to the plurality of vehicles, and each vehicle displays an advertisement on its display apparatuses that face outward. Each vehicle in the system outputs an advertisement (in the form of a still or moving image) it has received from the server apparatus by the outside display apparatuses provided on the vehicle body while it is travelling.

Systems that use moving advertising media are not capable of allowing users who have seen advertisements to share them with friends easily, unlike with online advertising systems.

The information processing apparatus according to the present disclosure is intended to enable sharing of advertisements. Specifically, when receiving a request from a first user, the information processing apparatus obtains location information of the first user and finds a first advertisement-displaying vehicle located in the vicinity of the first user. Moreover, the information processing apparatus sends the advertisement that has been displayed by the first advertisement-displaying vehicle to a second advertisement-displaying vehicle selected based on a designation by the first user to display the advertisement by the second advertisement-displaying vehicle.

The second advertisement-displaying vehicle is any vehicle that is selected based on an indication by the first user, which may be located at any geographical location without any limitation. For example, the second advertisement-displaying vehicle may be the vehicle the first user is presently aboard or a vehicle located in the vicinity of another user designated by the first user.

The information processing apparatus configured as above can cause the second advertisement-displaying vehicle to display the advertisement that has been displayed by the first advertisement-displaying vehicle. In other words, the information processing apparatus can enable someone to share an advertisement he or she has seen with another user at any place.

The second advertisement-displaying vehicle may be the vehicle the first user is presently aboard. This enables the vehicle the first user is aboard to display the advertisement selected by himself/herself.

The second advertisement-displaying vehicle may be a vehicle located in the vicinity of a second user having a relation with the first user. This enables the first user to share the content of the advertisement with the second user. The second user may be an acquaintance of the first user or a user having a connection with the first user on a social network or the like.

The second finding step may comprise the step of obtaining location information of the second user designated by the first user and the step of finding a second advertisement-displaying vehicle located in the vicinity of the second user on the basis of the location information of the second user.

It is possible to share an advertisement with a second user at a geographically remote place by obtaining location information of the second user and finding a vehicle located in the vicinity of the location indicated by the location information.

The display step may further comprise sending information associated with the advertisement displayed by the second advertisement-displaying vehicle to a terminal associated with the first user or a second user designated by the first user.

The terminal associated with the user may be a portable terminal such as a smartphone or an on-vehicle terminal. The information associated with the advertisement may be information (in the form of e.g. a still or moving image, an associated URL, or voices) associated with the subject of the advertisement. This enables the user to access detailed information about the shared advertisement.

The control unit may determine an incentive to be given to the first user in accordance with an action taken by a user who has seen the advertisement displayed by the second advertisement-displaying vehicle.

An incentive given in accordance with the result of sharing of an advertisement can motivate users to share advertisements.

In the following, specific embodiments of the present disclosure will be described with reference to the drawings. It should be understood that features such as hardware configurations, module configurations, and functional configurations that will be described in connection with the embodiments are not intended to limit the technical scope of the present disclosure only to them, unless otherwise stated.

### First Embodiment

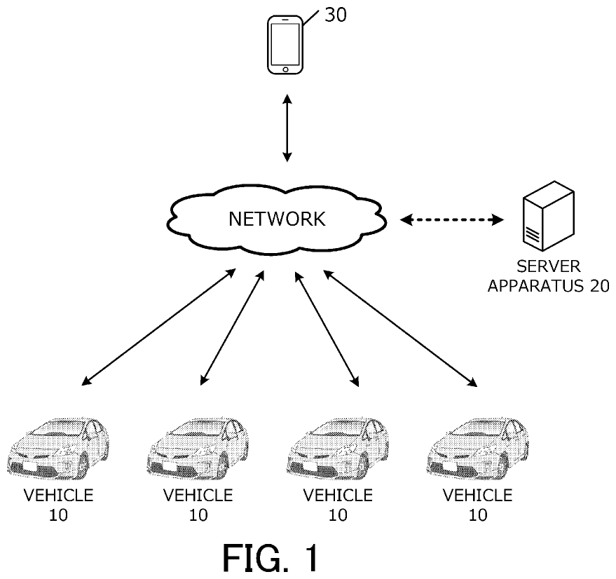

FIG. 1 is a diagram illustrating the general configuration of an advertisement distribution system according to a first embodiment. The advertisement distribution system according to the first embodiment includes a plurality of vehicles 10, a server apparatus 20, and user terminals 30 carried by users. In the following description of the embodiment, the term “user(s)” will be used to refer to an intended audience of an advertisement output by the vehicles 10.

The vehicle 10 is an automobile provided with a plurality of display apparatuses on the outside of its body. The vehicle 10 is capable of displaying an advertisement using advertisement data it has received from the server apparatus 20. The expression “displaying an advertisement” in the description of the embodiment means outputting image data to a display apparatus to display a still or moving image on it. The number of vehicles 10 included in the system is not limited to that in the illustrated case, but the system may include any number of vehicles 10.

The vehicle 10 receives advertisement data from the server apparatus 20 and outputs an advertisement to the display apparatuses while it is travelling. The vehicle 10 periodically sends information about the state of display of an advertisement (e.g. location information and information identifying the advertisement displayed) to the server apparatus 20.

The server apparatus 20 is a server that manages the vehicles 10 and advertisements to be displayed by the vehicles 10. The server apparatus 20 has data relating to advertising and data about the vehicles 10. The server apparatus 20 determines advertisements to be distributed to the vehicles 10, distributes advertisements to the vehicles 10, and performs management of results (e.g. makes a report to the advertiser or client).

The server apparatus 20 also manages the locations of travelling vehicles 10, records of their travel, identification data of the advertisements displayed by the vehicles 10.

The user terminal 30 is a terminal carried by a consumer (or user). The number of user terminals 30 included in the system is not limited to that in the illustrated case, but the system may include any number of user terminals 30.

The vehicles 10, the server apparatus 20, and the user terminals 30 in the advertisement distribution system according to the embodiment are interconnected by a network. Examples of the network include a wide area network (WAN), namely a global public network, such as the Internet, and other communication networks. Examples of the network also include a telephone communication network, such as a cellular phone network, and other wireless communication networks, such as Wi-Fi (registered trademark).

In response to a request sent from a user terminal 30 carried by a first user, the server apparatus 20 according to the embodiment has the function of causing a certain vehicle 10 located in the vicinity of a second user designated by the first user to display a certain advertisement.

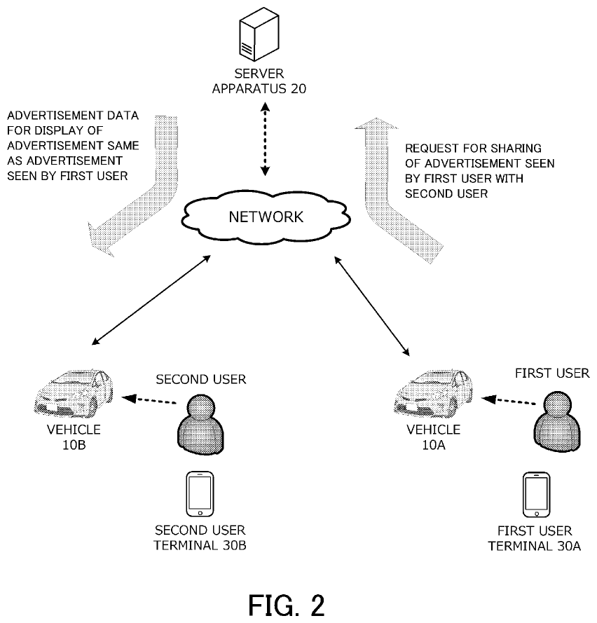

This function of the server apparatus 20 will now be described with reference to FIG. 2. The first user mentioned above is a user who requests sharing of a certain advertisement, and the second user is a user with whom the advertisement is to be shared.

In the following, the user terminal carried by the first user will be referred to as the first user terminal 30A, and a user terminal carried by the second user will be referred to as the second user terminal 30B. Moreover, a vehicle located in the vicinity of the first user will be referred to as a first vehicle 10A, and a vehicle located in the vicinity of the second user will be referred to as a second vehicle 10B.

If the first user who has seen a certain advertisement displayed by a first vehicle 10A wishes to share the advertisement with the second user, the first user sends a request for sharing of the advertisement with information designating the second user to the server apparatus 20 through the first user terminal 30A.

In response to this, the server apparatus 20 identifies the vehicle 10A that has displayed the advertisement on the basis of location information of the first user. Moreover, the server apparatus 20 finds a second vehicle 10B located in the vicinity of the second user on the basis of location information of the second user.

Then, the server apparatus 20 sends advertisement data to the second vehicle 10B so as to cause it to display the advertisement same as the advertisement that the first user saw.

By the above process, the advertising system that uses vehicles as media allows a user to share an advertisement with another user.

In the following description, the aforementioned request sent from the first user (for sharing of an advertisement with the second user) will be referred to as “sharing request”.

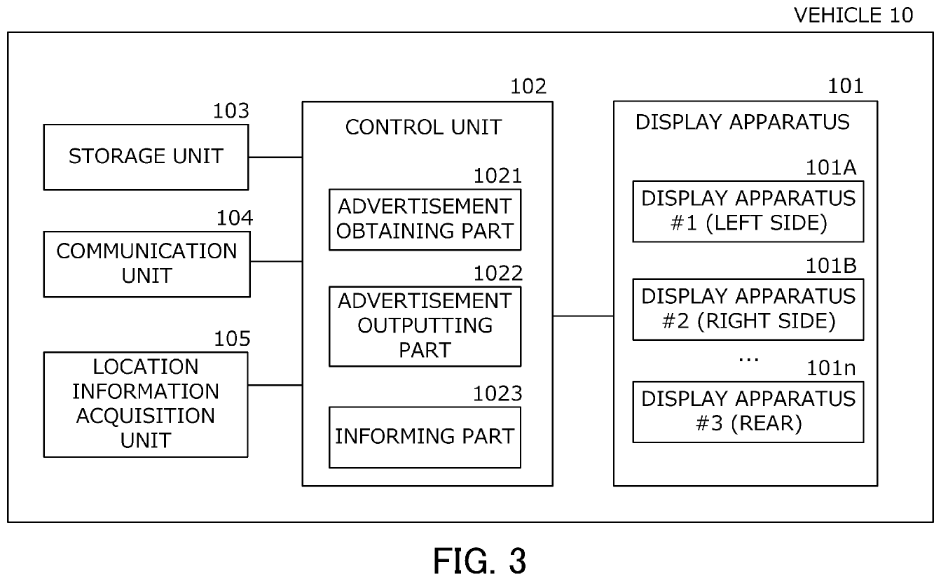

Now, the configuration of the vehicle 10 will be described. FIG. 3 is a diagram illustrating the system configuration of the vehicle 10.

The vehicle 10 includes a display unit 101, a control unit 102, a storage unit 103, a communication unit 104, and a location information acquisition unit 105.

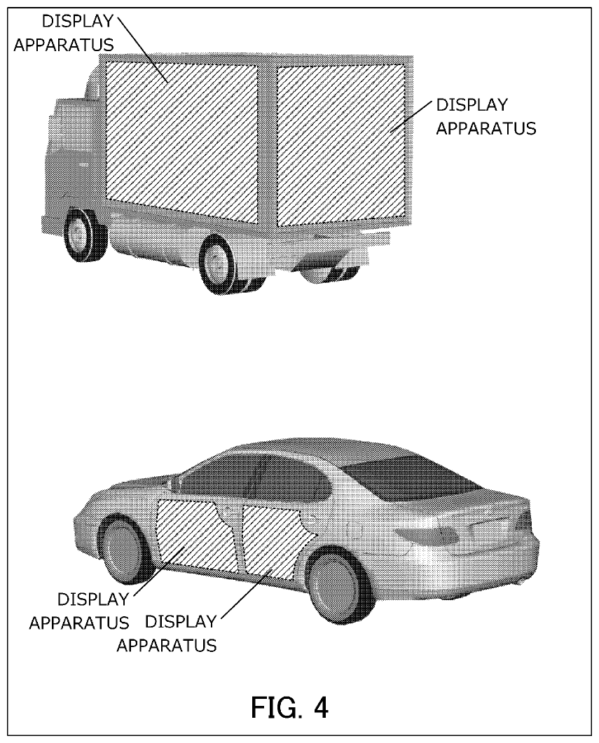

The display apparatus 101 includes a plurality of display apparatuses provided on the outside of the vehicle 10. As illustrated in FIG. 4, the vehicle 10 in the system according to the embodiment has a plurality of display apparatuses 101A, 101B, . . . , 101n that face outward. The display apparatuses will be collectively designated as the display apparatus 101, where identification of individual display apparatuses is not necessary.

The display apparatus 101 may be a liquid crystal display, an organic electroluminescence display, an LED matrix, or a projector.

The number of display apparatuses provided on one vehicle 10 varies depending on the type or model of the vehicle 10. Display apparatuses may be provided on different portions of the vehicle 10, for example, on the right and left sides, the rear, and the top of the vehicle. For example, a truck may have three display apparatuses provided on the right side, the left side, and the rear of the vehicle. A sedan may have four display apparatuses provided on the front door on the left side, the rear door on the left side, the front door on the right side, and the rear door on the right side.

Display apparatuses 101 may be provided at positions other than those described above. For example, if it is possible to project images on a sheet of glass, display apparatuses may be provided on windows (e.g. side and rear windows).

The control unit 102 is a computing device that controls the function of outputting advertisements among the functions of the vehicle 10. The control unit 102 may be implemented by a computational processing unit, such as a CPU (Central Processing Unit).

The control unit 102 includes three functional modules, which include an advertisement obtaining part 1021, an advertisement outputting part 1022, and an informing part 1023. These functional modules may be implemented by executing programs stored in the storage unit 103 (described later) by a CPU.

The advertisement obtaining part 1021 obtains data (or advertisement data) relating to an advertisement to be output on the display apparatus 101 from the server apparatus 20. It is preferred that the advertisement data be obtained just before the vehicle 10 starts to travel or while the vehicle 10 is travelling, though the timing of obtaining the advertisement data is not limited to these. The advertisement data may be obtained at the time when the ignition is turned on, when a destination is set, or when the vehicle 10 starts to travel. The advertisement data obtained by the advertisement obtaining part 1021 is stored in the storage unit 103, which will be described later.

The advertisement outputting part 1022 outputs an image or the like contained in the advertisement data to the display apparatus 101. A condition for outputting the advertisement may be specified in the advertisement data, and the advertisement may be output only when the condition is met. The advertisement data may designate the position and the size of the display apparatus, and the advertisement outputting part 1022 may output the advertisement according to the designations.

The informing part 1023 sends information about display of an advertisement to the server apparatus 20. Specifically, the informing part 1023 collects information about the present location of the vehicle, identification data of the advertisement presently displayed, and other information relating to the advertisement and sends them to the server apparatus 20.

Details of processing performed by the above-described modules will be described later

The storage unit 103 includes a main storage device and an auxiliary storage device. The main storage device is a memory into which programs executed by the control unit 102 and data used by such control programs are loaded. The auxiliary storage device is a device in which the programs executed by the control unit 102 and the data used by the control programs are stored. An operating system for executing the programs may also be stored in the auxiliary storage device. Programs stored in the auxiliary storage device are loaded into the main storage device and executed by the control unit 102 to implement the aforementioned functions.

The communication unit 104 is a wireless communication interface that connects the vehicle 10 to the network. The communication unit 104 provides access to the network via, for example, a wireless LAN or a mobile communication service based on 3G or LTE.

The location information acquisition unit 105 is a unit configured to acquire location information of the vehicle 10. The location information acquisition unit 105 includes, for example, a GPS module and acquires location information (e.g. latitude and longitude) of the vehicle 10.

FIG. 3 is given only to illustrate an exemplary configuration, and all or some of the functions shown in FIG. 3 may be implemented by circuits dedicated to the functions. Main and auxiliary storage devices other than those illustrated may be employed in combination to store and/or execute programs.

Next, the configuration of the server apparatus 20 will be described.

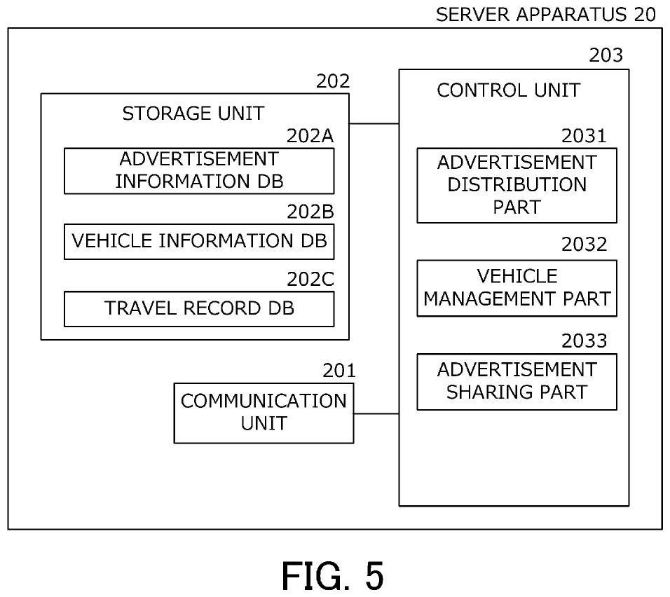

FIG. 5 is a diagram illustrating the system configuration of the server apparatus 20. The server apparatus 20 includes a communication unit 201, a storage unit 202, and a control unit 203.

The server apparatus 20 is constituted by an ordinary computer. Specifically, the server apparatus 20 is a computer including a processor(s), such as a CPU and/or a GPU, a main storage device(s), such as a RAM and/or a ROM, and an auxiliary storage device(s), such as an EPROM, a hard disk drive and/or a removable medium. Examples of the removable medium include a USB memory and a recording disc medium, such as a CD or DVD. What is stored in the auxiliary storage device includes an operating system (OS), various programs, and various tables. The programs stored in the auxiliary storage device are loaded into a workspace of the main storage device and executed to control various components, thereby providing appropriate functions for achieving desired purposes, which will be described later. All or some of the functions may be implemented by a hardware circuit, such as an ASIC or an FPGA. The server apparatus 20 may be constituted by a single computer or a plurality of computers that work in cooperation with each other.

The communication unit 201 is a communication interface that connects the server apparatus 20 to the network. The communication unit 201 includes, for example, a network interface board and a wireless communication circuit for providing wireless communication.

The storage unit 202 includes a main storage device and an auxiliary storage device. The main storage device is a memory into which programs executed by the control unit 203 and data used by such control programs are loaded. The auxiliary storage device is a device in which the programs executed by the control unit 203 and the data used by the control programs are stored. The main storage device and the auxiliary storage device are similar to those in the storage unit 103 and will not be described in further detail.

What is stored in the storage unit 202 also includes an advertisement information database 202A, a vehicle information database 202B, and a travel record database 202C.

The advertisement information database 202A is a database in which data relating to advertisements to be distributed to the vehicles 10 is stored. Such data is created by an advertiser(s).

The vehicle information database 202B is a database in which information about properties and characteristics of the vehicles 10 are stored. Such data is created when the vehicles 10 are registered in the system.

The travel record database 202C is a database in which records of travel of the vehicles 10 are stored. The record of travel includes, for example, a route or locations that the vehicle 10 has travelled, the status of display of an advertisement, and identification data of the displayed advertisement. The stored data is updated on the basis of information collected from the vehicles 10.

These databases are created by managing data stored in the storage device by a database management system program (DBMS program) executed by the processor. The databases used in the system according to the embodiment are, for example, relational databases.

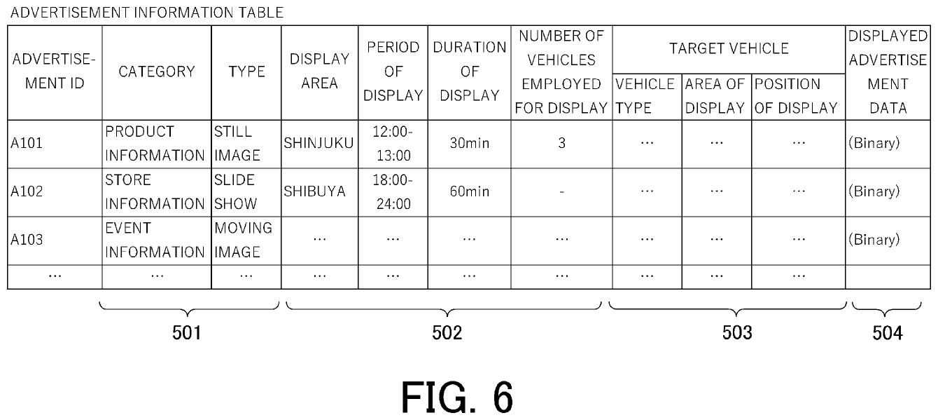

Data stored in the advertisement information database 202A will now be described with reference to FIG. 6. FIG. 6 illustrates an example of the content of an advertisement information table stored in the advertisement information database 202A. As illustrated, the information stored in the advertisement information table includes identification data of the advertisement (advertisement ID), information relating to properties of the advertisement (501), information relating to conditions for display of the advertisement (502), information designating a vehicle to be employed to display the advertisement (503), and data to be output to the display apparatus 101 of the vehicle (displayed advertisement data 504). The displayed advertisement data may be, for example, still image data, consecutive image data, or moving image data.

Each piece of data stored in the advertisement information database 202A will be referred to as “advertisement data”.

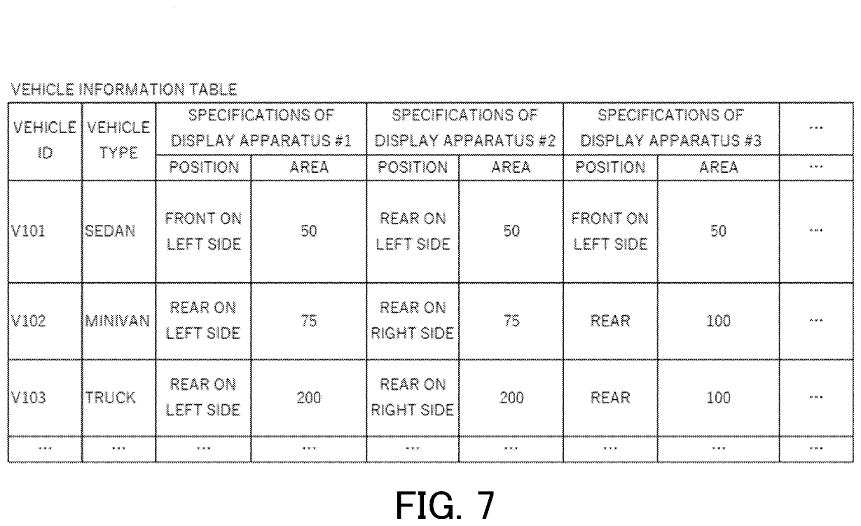

Next, data stored in the vehicle information database 202B will be described with reference to FIG. 7. FIG. 7 illustrates an example of the content of a vehicle information table stored in the vehicle information database 202B. The information stored in the vehicle information table includes information about the type of the vehicle and information about the display apparatus. Examples of the information about the display apparatus include, but are not limited to, the number of display apparatuses, the positions at which the display apparatuses are provided, and the area of each display.

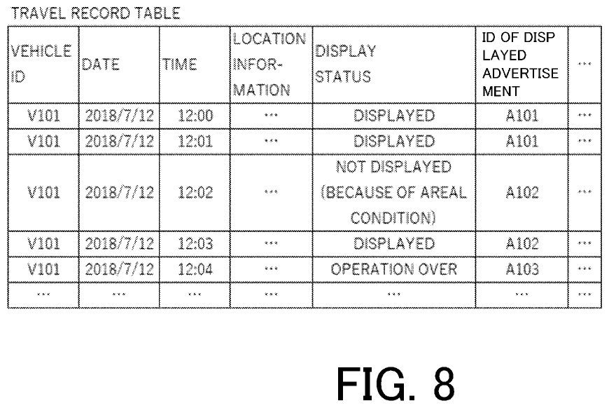

Data stored in the travel record database 202C will be described with reference to FIG. 8. FIG. 8 illustrates an example of the content of a travel record table stored in the travel record database 202C. Information stored in the travel record table includes identification data of the vehicle (vehicle ID), date and time, location information (e.g. latitude and longitude) of the vehicle 10, the status of display of advertisement, identification data of the advertisement displayed at the time (advertisement ID).

The display status is information indicating the status of display of advertisement, examples of which include “DISPLAYED”, “NOT DISPLAYED”, “PARKED”, and “OPERATION OVER” (indicating that the operation has ended). When display of advertisement is not performed for some reason, such as that the vehicle 10 is travelling outside the area designated by the advertiser or the time of travel does not fall in the designated time period, the display status may include the reason.

How the data stored in the databases is used will be described later.

The control unit 203 is a computing unit that executes control performed by the server apparatus 20. The control unit 203 may be implemented by a computational processing unit, such as a CPU.

The control unit 203 includes as functional modules an advertisement distribution part 2031, a vehicle management part 2032, and an advertisement sharing part 2033. These three functional modules may be implemented by executing programs stored in auxiliary storage by the CPU.

The advertisement distribution part 2031 determines an advertisement to be displayed by a designated vehicle 10 and sends corresponding advertisement data to the vehicle 10.

The vehicle management part 2032 periodically communicates with the vehicles 10 to collect location information of the vehicles 10 and identification data of the respective advertisements displayed by the vehicles 10 and updates the travel record database 202C.

When a sharing request is sent from the user terminal 30 carried by a first user, the advertisement sharing part 2033 infers the advertisement seen by the first user on the basis of location information of the user terminal 30 and causes a vehicle 10 located in the vicinity of a second user designated by the first user to display the advertisement on the basis of location information of the second user (or location information of the user terminal carried by the second user).

Details of this process will be described later.

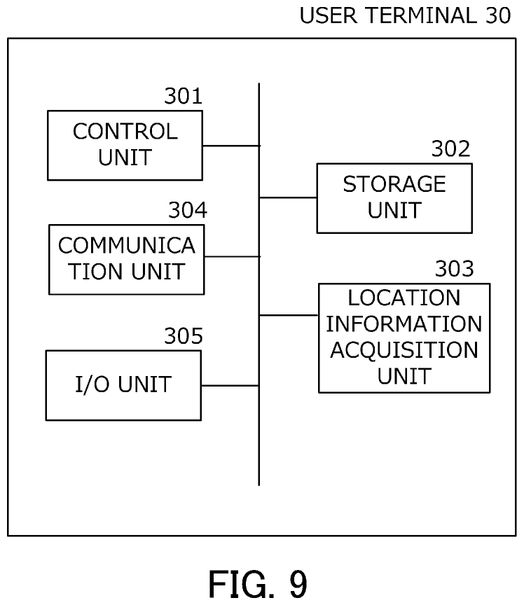

Next, the configuration of the user terminal 30 will be described. FIG. 9 is a diagram illustrating the system configuration of the user terminal 30.

The user terminal 30 is a small-size computer, such as a smartphone, a cellular phone, a tablet computer, a personal information terminal, a laptop computer, or a wearable computer (e.g. smartwatch). The user terminal 30 includes a control unit 301, a storage unit 302, an location information acquiring unit 303, a communication unit 304, and an input and output unit 305.

The control unit 301 is a computing unit that executes control performed by the user terminal 30. The control unit 301 may be implemented by a computational processing unit, such as a CPU (Central Processing Unit).

The control unit 301 accesses the server apparatus 20 and executes the function of requesting information relating to the advertisement displayed by a vehicle 10.

Details of this process will be described later.

The storage unit 302 includes a main storage device and an auxiliary storage device. The main storage device is a memory into which programs executed by the control unit 301 and data used by such control programs are loaded. The auxiliary storage device is a device in which the programs executed by the control unit 301 and the data used by the control programs are stored. A package of application programs executed by the control unit 301 may be stored in the auxiliary storage device. An operating system for executing the application programs may also be stored in the auxiliary storage device. Programs stored in the auxiliary storage device are loaded into the main storage device and executed by the control unit 301 to execute processing described in the following.

The main storage device may include a RAM (Random Access Memory) and/or a ROM (Read Only Memory). The auxiliary storage device may include an EPROM (Erasable Programmable ROM) and/or a hard disk drive (HDD). The auxiliary storage device may also include a removable medium, namely a portable recording medium. Examples of the removable medium include a USB memory (Universal Serial Bus memory) and a recording disc medium, such as a CD (Compact Disc) or a DVD (Digital Versatile Disc).

The location information acquisition unit 303 is a unit configured to acquire location information of the user terminal 30. The location information acquisition unit 303 includes, for example, a GPS module and acquires location information (e.g. latitude and longitude) of the user terminal 30.

The communication unit 304 is a wireless communication interface that connects the user terminal 30 to the network. The communication unit 304 provides access to the network via, for example, a wireless LAN or a mobile communication service based on 3G or LTE.

The input and output unit 305 is a unit configured to receive input operations by a user and provide information to the user. The input and output unit 305 of the user terminal 30 according to the embodiment is constituted by a single touch-panel display, which includes a liquid crystal display, its control unit, a touch panel, and its control unit.

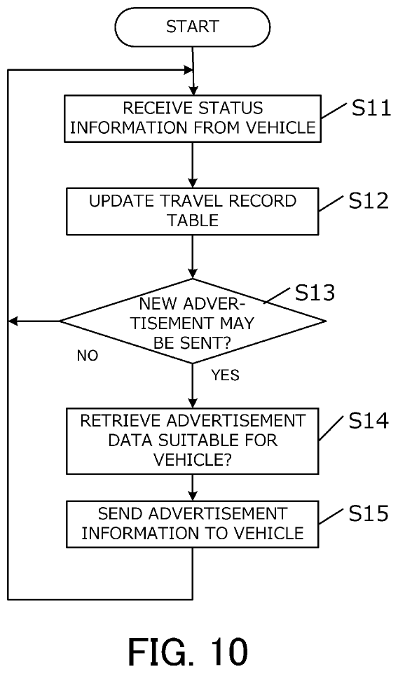

Next, we will describe how the advertisement distribution system according to the embodiment distributes advertisements to the vehicles 10 to cause them to display the advertisements. FIG. 10 is a flow chart of a process executed by the server apparatus 20. The server apparatus 20 executes the process according to the flow chart in FIG. 10 periodically (or every unit time) for each of the vehicles 10 under its management.

Firstly in step S11, the server apparatus 20 receives status information from the vehicles 10 under its management. The status information includes information about the present location of each vehicle, the identification data of the presently displayed advertisement, and the status of display of advertisement. In this step, specifically, the vehicle management part 2032 sends an inquiry to each of the vehicles 10 (specifically, the informing part 1023 thereof). In response to the inquiry, the informing part 1023 of each vehicle 10 sends location information acquired by the location information acquisition unit 105, information about whether or not there is an advertisement presently on display (with the ID of the advertisement, if affirmative), and the status of display of advertisement as the status information. Details of the processing performed by the vehicle 10 will be described later with reference to FIG. 10.

While in the system according to the embodiment the server apparatus 20 periodically sends an inquiry to the vehicles 10, each vehicle 10 may periodically send the aforementioned information to the server apparatus 20 by push communication alternatively. In this alternative case, the processing of step S11 is not necessarily executed at the timing indicated in FIG. 9.

Then in step S12, the server apparatus 20 updates the travel record table based on the status information received from the vehicle 10. Specifically, the vehicle management part 2032 adds a record including the vehicle ID, date, time, location information, display status, and displayed advertisement ID (if an advertisement is on display) to the travel record table stored in the travel record database 202C.

Then in step S13, it is determined whether or not new advertisement data may be sent to the subject vehicle 10 (namely, the vehicle for which this process is being performed). If a negative determination is made in step S13, the process proceeds to step S11, and the subject of the process is changed to another vehicle 10.

Whether or not new advertisement data may be sent to a certain vehicle 10 can be determined by whether or not the properties of the vehicle 10 satisfy the condition set for each advertisement. For example, in the case where a condition relating to the vehicle type and the display apparatus of the vehicle (like data 503 in FIG. 6) is set, whether or not new advertisement data may be sent to a certain vehicle 10 is determined by whether or not the properties of the vehicle 10 meet this condition.

Alternatively, whether or not advertisement data may be sent to a certain vehicle 10 may be determined by consulting information about the vehicle 10. For example, information about the preference of the owner of the vehicle 10 may be stored in the vehicle information table, and an advertisement to be distributed to the vehicle 10 may be determined using this information.

If there is an advertisement for which the subject vehicle 10 meets the condition, information relating to the advertisement is retrieved (in step S14) and sent to the vehicle 10 (step S15).

Even when it is determined that advertisement data may be sent to the vehicle 10, there may be cases where the advertisement data is not sent for the reason that a certain condition relating to the vehicle is not met. For example, the reception of advertisement data may be rejected by the vehicle 10 in some circumstances.

The above-described process is executed repeatedly for every vehicle 10 under the management of the server apparatus 20.

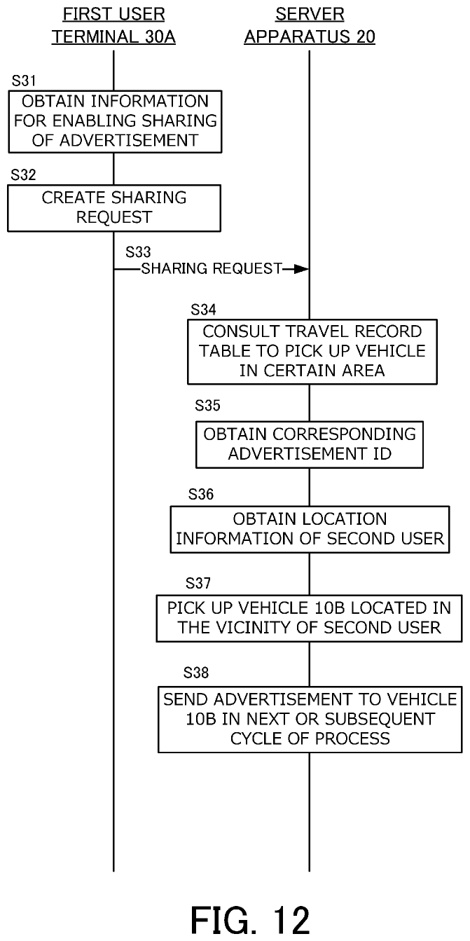

According to this embodiment, when receiving a request for sharing of an advertisement from a user, the server apparatus 20 executes the process according to the flow chart in FIG. 10 on the basis of the sharing request to determine the advertisement to be sent to the vehicle. This process will be described specifically later with reference to FIG. 12.

Next, the process executed by the vehicle 10 will be described. The process executed by the vehicle 10 is the process of sending and receiving data relating to advertisement to and from the server apparatus 20 and starting and stopping display of an advertisement.

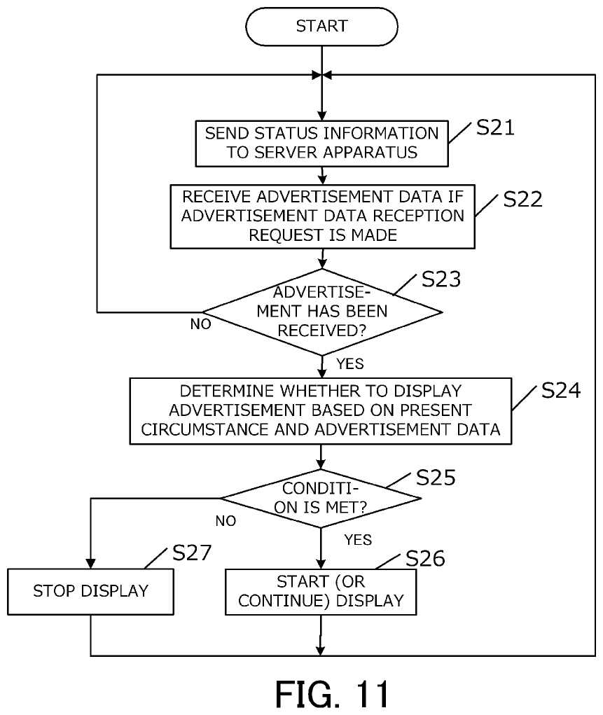

FIG. 11 is a flow chart of the first process executed by the vehicle 10. This process is executed by the vehicle 10 at the time when the inquiry from the server apparatus 20 is received.

Firstly, in step S21, the informing part 1023 sends the following information to the server apparatus 20:

(1) location information acquired by the location information acquisition unit 105

(2) the presence/absence of displayed advertisement (with its ID, if present)

(3) the status of display of advertisement

While in the system according to this embodiment the vehicle 10 sends information in response to the inquiry sent from the server apparatus 20, the vehicles 10 may send the aforementioned information to the server apparatus 20 at predetermined intervals by push communication alternatively. In this alternative case, the processing of steps S21 is not necessarily executed at the timing indicated in FIG. 10.

Then, in step S22, it is determined whether or not reception of advertisement data is requested by the server apparatus 20, and if it is requested, the vehicle 10 receives the advertisement data.

Then, in step S23, it is determined whether or not the advertisement outputting part 1022 has already received the advertisement data from the server apparatus 20. If a negative determination is made in step S23 (i.e. the vehicle 10 has no advertisement data), the process returns to step S21. If an affirmative determination is made in step S23, the process proceeds to step S24, where it is determined whether or not the advertisement is to be displayed on the basis of comparison between the present circumstance and the condition set in the advertisement data the vehicle 10 has received.

For example, if it is designated in the advertisement data that the advertisement should be displayed only in a designated area, whether the advertisement is to be displayed or not is determined on the basis of the result of comparison of the condition relating to the area and the location information acquired by the location information acquisition unit 105. If it is designated in the advertisement data that the advertisement should be displayed only in a designated time period, whether the advertisement is to be displayed or not is determined on the basis of the result of comparison of the condition relating to the time period and the present date and time.

While area and time period are given as examples of conditions for determining whether the advertisement is to be displayed or not, other conditions based on which the vehicle 10 can make the determination may be set.

If the result of determination in step S24 indicates that the condition is met (Yes in step S25), the process proceeds to step S26, where display of the advertisement is started (or continued, if the advertisement has already been displayed). If data of a plurality of advertisements are stored in the vehicle 10, the advertisement to be displayed may be selected according to a certain condition.

If the condition is not met (No in Step S25), the process proceeds to step S27, where display of the advertisement is ended.

In step 27, it may be determined whether or not display of the advertisement is to be ended. For example, in the case where a total display time is designated for a certain advertisement, if the total display time of the advertisement has elapsed, it is determined that display of this advertisement is to be ended. Furthermore, if the operation (or travel) of the vehicle 10 that displays a certain advertisement ends (e.g. if the ignition is turned off), it is determined that display of the advertisement is to be ended. After display of an advertisement is ended, the advertisement data for this advertisement may be deleted.

The vehicle 10 displays the advertisement by the above process.

Next, how a user who has seen an advertisement displayed by a vehicle 10 shares the advertisement with another user will be described.

As described above, location information of the vehicles 10 and the IDs of the advertisements displayed by the vehicles 10 are managed by the server apparatus 20. Specifically, the location information and the IDs are recorded in the travel record table. Therefore, the server apparatus 20 can infer the advertisement that the user at a certain location has seen by consulting the travel record table.

FIG. 12 is a flow chart illustrating a process carried out by components of the system and dataflow between them.

The process according to the flow chart in FIG. 12 is started by an operation made on the first user terminal 30A by a first user who has seen an advertisement displayed by a vehicle 10.

Firstly in step S31, the first user inputs information for enabling sharing of the advertisement to the first user terminal 30A through the input and output unit 305. Specifically, the first user inputs information indicating that he or she wishes to share the advertisement displayed in his/her neighborhood and information designating a second user with whom the advertisement is to be shared.

The information designating the second user may be any information by which the geographical location of the second user can be determined. For example, if the second user terminal 30B carried by the second user is capable of sending its location information, the information indicating the second user may be identification data (e.g. hardware identifier) of the second user terminal 30B. If the second user is presently aboard a vehicle that is capable of sending its location information, identification data of that vehicle may be used as the information designating the second user. A user account of the second user used to log in the second user terminal 30B (or an operating system or application running in the terminal) may also be used as the information designating the second user. For example, a user ID for a social network may be used. The geographical location of the second user is determined by the server apparatus 20 in step S36 of this process, which will be described later.

Then in step S32, the first user terminal 30A creates a sharing request. The sharing request contains information designating the second user and location information of the first user terminal 30A. The location information of the first user terminal 30A can be acquired through the location information acquisition unit 303.

The sharing request thus created is sent to the server apparatus 20 in step S33.

Then in step S34, the server apparatus 20 (specifically, the advertisement sharing part 2033 thereof) consults the travel record table to pick up a vehicle 10 that is located within a certain range from the location indicated by the location information of the first user terminal 30A. This range may be a range within which the user can see the advertisement. The vehicle may be picked up on the basis of only the location information or the location information and time information.

Then, in step S35, the server apparatus 20 obtains the ID of the advertisement that has displayed by the vehicle 10 picked up in step S34. If there are a plurality of candidates of the vehicle 10 that has displayed the advertisement seen by the first user, for example if there are a plurality of vehicles 10 located within the aforementioned range, the server apparatus 20 may narrow down the candidates of the first vehicle by a certain condition. If there are a plurality of candidates of the vehicle 10 (or the advertisement), the server apparatus 20 may send a list of the candidates to the first user terminal 30A to let the first user select the advertisement intended to be shared.

Thus, the advertisement seen by the first user is identified by the processing of step S35.

Then, in step S36, the server apparatus 20 (specifically, the advertisement sharing part 2033) obtains location information of the second user. Examples of the way of obtaining location information of the second user are as follows.

(1) making an inquiry to the second user terminal

In the case where the second user terminal 30B is a member of the advertisement distribution system according to the embodiment, the server apparatus 20 can obtain location information of the second user terminal 30B by making an inquiry to the second user terminal 30B. In this case, the server apparatus 20 may notify the second user that a request for sharing of an advertisement has been made by the first user and ask the second user whether or not he/she approves provision of location information to the server apparatus 20.

(2) making an inquiry to the vehicle the second user is aboard

In the case where the vehicle the second user is aboard (which may be either a vehicle 10 or an ordinary vehicle) is a member of the advertisement distribution system according to the embodiment, the server apparatus 20 can obtain location information of the second user terminal 30B by making an inquiry to this vehicle (or a computer or on-vehicle terminal provided in this vehicle). In this case, the server apparatus 20 may notify the second user that a request for sharing of an advertisement has been made by the first user and ask the second user whether or not he/she approves provision of location information to the server apparatus 20. Moreover, the server apparatus 20 may make an inquiry as to whether the second user is aboard this vehicle or not.

(3) making an inquiry to another server apparatus that is communicating with the second user terminal

The server apparatus 20 may obtain location information of the second user through another service without directly communicating with the second user terminal. For example, if the second user terminal is registered on a social network service, the server apparatus 20 may obtain location information of the second user by making an inquiry to a server that provides the service. In this case, the server apparatus 20 may ask the second user whether or not he/she approves provision of location information to the server apparatus 20.

Then in step S37, the server apparatus 20 (specifically, the advertisement sharing part 2033) consults the travel record table to pick up a second vehicle 10B that is located within a certain range from the location indicated by the location information of the second user terminal 30B. It is preferred that this range be small enough to allow the second user to see the advertisement displayed by the second vehicle 20.

After the completion of the processing of step S37, the advertisement (advertisement ID) to be shared and at least one vehicle 10B by which the advertisement is to be displayed have been determined. Information about the combination of the advertisement ID and the vehicle ID of the vehicle 10B is temporarily saved in step S38, and data of this advertisement is sent to the vehicle 10B when the processing of steps S13 to S15 in the process according to the flow chart in FIG. 10 is executed. Thus, the second user can see the advertisement designated by the first user.

When performing the process of sharing an advertisement, the server apparatus 20 may send a notice to the second user terminal 30B to notify the second user that a request for sharing of an advertisement has been made by the first user. In doing so, the server apparatus 20 may transfer a message from the first user to the second user terminal 30. The server apparatus 20 may execute the processing of step S34 onward only when the second user consents to sharing.

As above, the advertisement distribution system according to the first embodiment displays an advertisement seen by the first user by a vehicle that is located in the vicinity of the second user designated by the first user. This enables sharing of an advertisement by users that are located remote from each other.

Even when a sharing request is made, distribution of the advertisement may be cancelled if a condition relating to the vehicle 10 to display the advertisement is not met. For example, if a condition specified in the advertisement information table (e.g. the designated area, time, or vehicle type) or a condition set with the vehicle 10 (e.g. acceptable categories of advertisement designated by the owner of the vehicle 10) is not met, distribution of the advertisement may be cancelled.

### Second Embodiment

In the system according to the first embodiment, a first user designates a second user, and a second vehicle 10B located in the vicinity of the second user is employed to enable sharing of an advertisement. In the system according to the second embodiment described in the following, the first user shares an advertisement using the vehicle 10 the first user is aboard, with people around the vehicle 10.

In the system according to the second embodiment, when the first user creates a sharing request (in step S32 in the process according to the flow chart in FIG. 12), information designating the vehicle 10 the first user is aboard is included in the request instead of the information designating the second user. Moreover, the processing of steps S36 and S37 is eliminated, and the vehicle 10 the first user is aboard is selected as the vehicle to which data of the advertisement is to be sent (i.e. the second vehicle) in step S38. The vehicle 10 the first user is aboard may be identified by using information stored in the system or making an inquiry to the first user terminal 30A.

According to the second embodiment, the user can share an advertisement using the vehicle 10 the user is aboard.

### Third Embodiment

The system according to the first embodiment enables sharing of an advertisement using a vehicle 10B located in the vicinity of the second user, and the system according to the second embodiment enables sharing of an advertisement using the vehicle 10A the first user is aboard. The system according to the third embodiment is configured to send information associated with advertisement to a portable terminal that the first or second user carries.

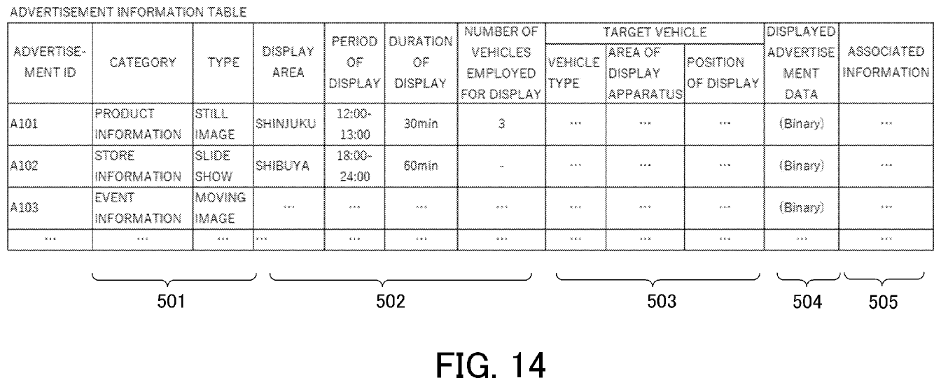

FIG. 14 shows an example of an advertisement information table according to the third embodiment. As illustrated in FIG. 14, according to the third embodiment, information associated with each advertisement (associated information 505) is stored in the advertisement information table. Specifically, detailed information relating to each advertisement is stored in the associated information field 505. The associated information may be a document written in a plain text or a markup language.

According to the third embodiment, after the completion of the processing of step S35 in the process according to the flow chart in FIG. 12, the server apparatus 20 retrieves associated information to be sent to the first user terminal 30A or the second user terminal 30B.

The first user terminal 30A may inform the server apparatus 20 of whether the information is to be sent to the first user (or the first user terminal 30A) or the second user (or the second user terminal 30B) when sending the sharing request.

Then, the server apparatus 20 prepares data to be provided to the user terminal on the basis of the advertisement ID obtained in step S35 and the associated information stored in the advertisement information table. For example, the server apparatus 20 may create a webpage containing detailed information relating to the advertisement in HTML. Thus, the first user (or the second user) can obtain information relating to the advertisement displayed by the vehicle 10.

While in the third embodiment the associated information is sent to a user terminal, it may be sent to other terminals. For example, if it is possible to identify the vehicle the first or second user is aboard, the associated information may be sent to an on-vehicle terminal provided in that vehicle.

When a certain action is made by the second user terminal, the advertisement sharing part 2033 may calculate an incentive to be given to the first user. Examples of such an action include access to the associated information, purchase of the advertised item, and guidance to the advertised store. The incentive may be points or electronic money that are effective in a specific online store. This can motivate users to share advertisements.

### Other Modifications

The processing and units that have been described in the foregoing may be employed in any combinations so long as it is technically feasible to do so.

While it has been described that the first user designates a second user, the designation of the second user is not essential. For example, the system may be configured to automatically select a user(s) who has attributes similar to the first user as the second user(s). Alternatively, the first user may designate only attributes of second users. When selecting second user(s) on the basis of the attributes designated by the first user, the system may consult attribution data of users stored in the system according to the embodiment or other social networks etc. Examples of the attributes include, but are not limited to, gender, age, place of residence, occupation, family structure, present location, and the type and manufacturer of a vehicle(s) the user own.

The second user who has shared an advertisement with the first user may further share the advertisement with another user(s).

A process described to be performed by one apparatus may be performed by a plurality of apparatuses in a distributed manner. A process described to be performed by different apparatuses may be performed by a single apparatus. The hardware configuration (or server configuration) employed to implement the functions of a computer system may be modified flexibly.

The present disclosure can be carried out by supplying a computer program(s) that implements the functions described in the above description of the embodiment to a computer to let one or more processors of the computer read and execute the program(s). Such a computer program(s) may be supplied to the computer by a computer-readable, non-transitory storage medium that can be connected to a system bus of the computer, or through a network. Examples of the computer-readable, non-transitory storage medium include any type of disc medium including, a magnetic disc, such as a floppy (registered trademark) disc and a hard disk drive (HDD), and an optical disc, such as a CD-ROM, a DVD and a Blu-ray disc, a read-only memory (ROM), a random access memory (RAM), an EPROM, an EEPROM, a magnetic card, a flash memory, an optical card, and any type of medium suitable for storage of electronic commands.

What is claimed is:

1. An information processing apparatus for displaying an advertisement using one or more vehicles having a display apparatus provided on the outside, including a control unit configured to execute processing comprising:
the step of obtaining location information of a first user who sees an advertisement;
the first finding step of finding a first advertisement-displaying vehicle located in the vicinity of the first user;
the second finding step of finding a second advertisement-displaying vehicle on the basis of a designation by the first user; and
the display step of sending the advertisement displayed by the first advertisement-displaying vehicle to the second advertisement-displaying vehicle to display the advertisement by the second advertisement-displaying vehicle.

2. An information processing apparatus according to claim 1, wherein
the second advertisement-displaying vehicle is the vehicle the first user is aboard.

3. An information processing apparatus according to claim 1, wherein
the second advertisement-displaying vehicle is a vehicle located in the vicinity of a second user having a relation with the first user.

4. An information processing apparatus according to claim 3, wherein
the second finding step comprises:
the step of obtaining location information of the second user designated by the first user; and
the step of finding the second advertisement-displaying vehicle located in the vicinity of the second user on the basis of the location information of the second user.

5. An information processing apparatus according to claim 1, wherein
the display step further comprises sending information associated with the advertisement displayed by the second advertisement-displaying vehicle to a terminal associated with the first user or a second user designated by the first user.

6. An information processing apparatus according to claim 1, wherein
the control unit determines an incentive to be given to the first user in accordance with an action taken by a user who has seen the advertisement displayed by the second advertisement-displaying vehicle.

7. An information processing method for displaying an advertisement using one or more vehicles having a display apparatus provided on the outside, comprising:
the step of obtaining location information of a first user who sees an advertisement;
the first finding step of finding a first advertisement-displaying vehicle located in the vicinity of the first user;
the second finding step of finding a second advertisement-displaying vehicle on the basis of a designation by the first user; and
the display step of sending the advertisement displayed by the first advertisement-displaying vehicle to the second advertisement-displaying vehicle to display the advertisement by the second advertisement-displaying vehicle.

8. A non-transitory computer readable storing medium recording a computer program for causing an information processing apparatus for displaying an advertisement using one or more vehicles having a display apparatus provided on the outside to perform a method comprising:
the step of obtaining location information of a first user who sees an advertisement;
the first finding step of finding a first advertisement-displaying vehicle located in the vicinity of the first user;
the second finding step of finding a second advertisement-displaying vehicle on the basis of a designation by the first user; and
the display step of sending the advertisement displayed by the first advertisement-displaying vehicle to the second advertisement-displaying vehicle to display the advertisement by the second advertisement-displaying vehicle.
